(19) United States
(12) Patent Application Publication
(10) Pub. No.: US 2007/0288694 A1
(43) Pub. Date: Dec. 13, 2007

(54) DATA PROCESSING SYSTEM, PROCESSOR AND METHOD OF DATA PROCESSING HAVING CONTROLLABLE STORE GATHER WINDOWS

(76) Inventors: Sanjeev Ghai, Round Rock, TX (US); Guy L. Guthrie, Austin, TX (US); Hugh Shen, Round Rock, TX (US); William J. Starke, Round Rock, TX (US); Derek E. Williams, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/423,717

(22) Filed: Jun. 13, 2006

(51) Int. Cl. G06F 12/00

(52) U.S. Cl. 711/118

(57) ABSTRACT

A data processing system includes a processor core and a memory subsystem coupled to the processor core. The memory subsystem includes data storage and a store queue including a plurality of entries for buffering store operations to be performed with reference to the data storage. The memory subsystem further includes a store queue controller that gathers multiple store requests received from the processor core into a single store operation buffered within an entry of the store queue. The store queue controller applies store gathering windows of differing durations to differing ones of the plurality of entries in response to control information received from the processor core.

### BACKGROUND OF THE INVENTION

1. Technical Field

The present invention relates generally to data processing, and in particular, to memory access requests in a data processing system. Still more particularly, the present invention relates to a data processing system, processing unit, memory subsystem and method of data processing having controllable store gather windows.

2. Description of the Related Art

A conventional symmetric multiprocessor (SMP) computer system, such as a server computer system, includes multiple processing units all coupled to a system interconnect, which typically comprises one or more address, data and control buses. Coupled to the system interconnect is a system memory, which represents the lowest level of volatile memory in the multiprocessor computer system and which generally is accessible for read and write access by all processing units. In order to reduce access latency to instructions and data residing in the system memory, each processing unit is typically further supported by a respective multi-level cache hierarchy, the lower level(s) of which may be shared by one or more processor cores.

Cache memories are commonly utilized to temporarily buffer memory blocks that might be accessed by a processor in order to speed up processing by reducing access latency introduced by having to load needed data and instructions from memory. In some multiprocessor (MP) systems, the cache hierarchy includes at least two levels. The level one (L1), or upper-level cache is usually a private cache associated with a particular processor core and cannot be accessed by other cores in an MP system. Typically, in response to a memory access instruction such as a load or store instruction, the processor core first accesses the directory of the upper-level cache. If the requested memory block is not found in the upper-level cache, the processor core then access lower-level caches (e.g., level two (L2) or level three (L3) caches) for the requested memory block. The lowest level cache (e.g., L3) is often shared among several processor cores.

In such conventional MP systems, a processor core issues a series of individual load and store operations to its associated cache hierarchy in response to the execution of corresponding load and store instructions. Such processor store operations generally target less than a full memory block of data. In order to increase store performance in the cache hierarchy, it is conventional to “gather” multiple individual processor store operations targeting the same memory block into a single store operation and then perform the indicated update to a cached copy of the target memory block.

In typical implementations, gathering of stores targeting a memory block is performed for a fixed period of time or until a barrier (e.g., sync) operation is received. The present invention recognizes, however, that different types of program code (e.g., scientific and commercial code) exhibit different store behaviors, meaning that the ideal period of store gathering for each given memory block varies depending upon the type of program code under execution. Consequently, the present invention recognizes that it would be useful and desirable to provide a data processing system, processing unit, memory subsystem and method of data processing that supports controllable store gathering windows of differing durations.

### SUMMARY OF THE INVENTION

A data processing system includes a processor core and a memory subsystem coupled to the processor core. The memory subsystem includes data storage and a store queue including a plurality of entries for buffering store operations to be performed with reference to the data storage. The memory subsystem further includes a store queue controller that gathers multiple store requests received from the processor core into a single store operation buffered within an entry of the store queue. The store queue controller applies store gathering windows of differing durations to differing ones of the plurality of entries in response to control information received from the processor core.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a high-level block diagram of an exemplary data processing system in accordance with the present invention;

FIG. 2A is a more detailed block diagram of an exemplary processing unit in accordance with the present invention;

FIG. 2B illustrates an exemplary store instruction containing one or more gathering window duration fields in accordance with the present invention;

FIG. 3 is a more detailed block diagram of an L2 cache slice in accordance with the present invention;

FIG. 4 is a more detailed block diagram of an exemplary embodiment of the L2 store queue of FIG. 3;

FIG. 5 is a high level logical flowchart of an exemplary process by which a store queue controller places store operations into a store queue of a cache memory in accordance with the present invention;

FIG. 6 illustrates an exemplary store operation containing one or more gathering window duration fields in accordance with the present invention;

FIG. 7 is a level logical flowchart of an exemplary process by which a store queue controller manages the dispatchable status of entries within a store queue of a cache memory accordance with the present invention; and

FIG. 8 is a high level logical flowchart of an exemplary process by which a store queue controller dispatches store operations from a store queue for processing in accordance with the present invention.

### DETAILED DESCRIPTION OF ILLUSTRATIVE EMBODIMENT(S)

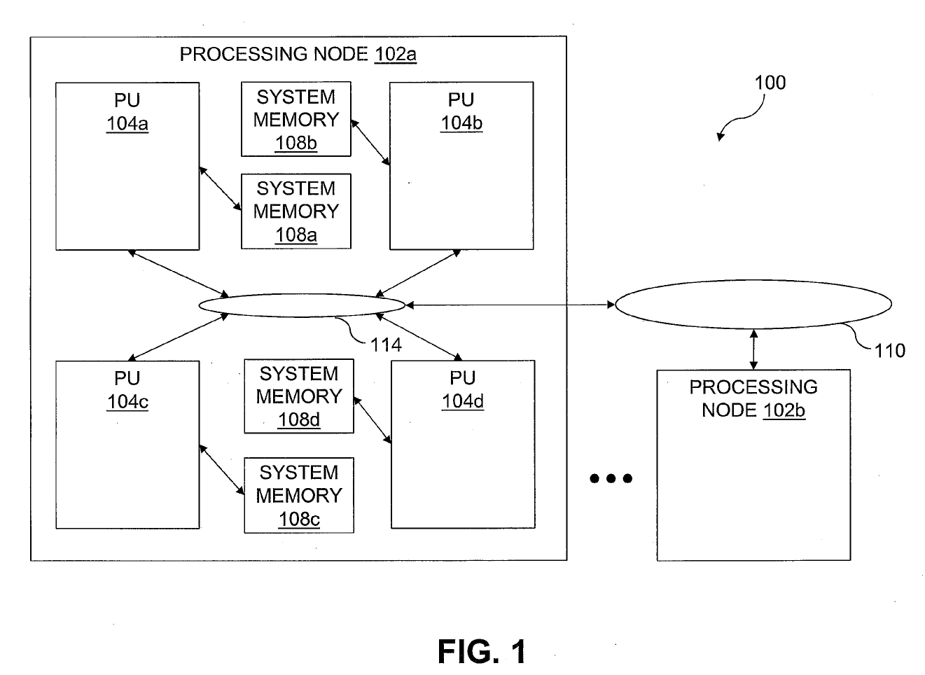

With reference now to the figures, wherein like reference numerals refer to like and corresponding parts throughout, and in particular with reference to FIG. 1, there is illustrated a high-level block diagram depicting an exemplary data processing system in which the present invention may be implemented. The data processing system is depicted as a cache coherent symmetric multiprocessor (SMP) data processing system 100. As shown, data processing system 100 includes multiple processing nodes 102a, 102b for processing data and instructions. Processing nodes 102 are coupled to a system interconnect 110 for conveying address, data and control information. System interconnect 110 may be implemented, for example, as a bused interconnect, a switched interconnect or a hybrid interconnect.

In the depicted embodiment, each processing node 102 is realized as a multi-chip module (MCM) containing four processing units 104a-104d, each preferably realized as a respective integrated circuit. The processing units 104 within each processing node 102 are coupled for communication to each other and system interconnect 110 by a local interconnect 114, which, like system interconnect 110, may be implemented, for example, with one or more buses and/or switches.

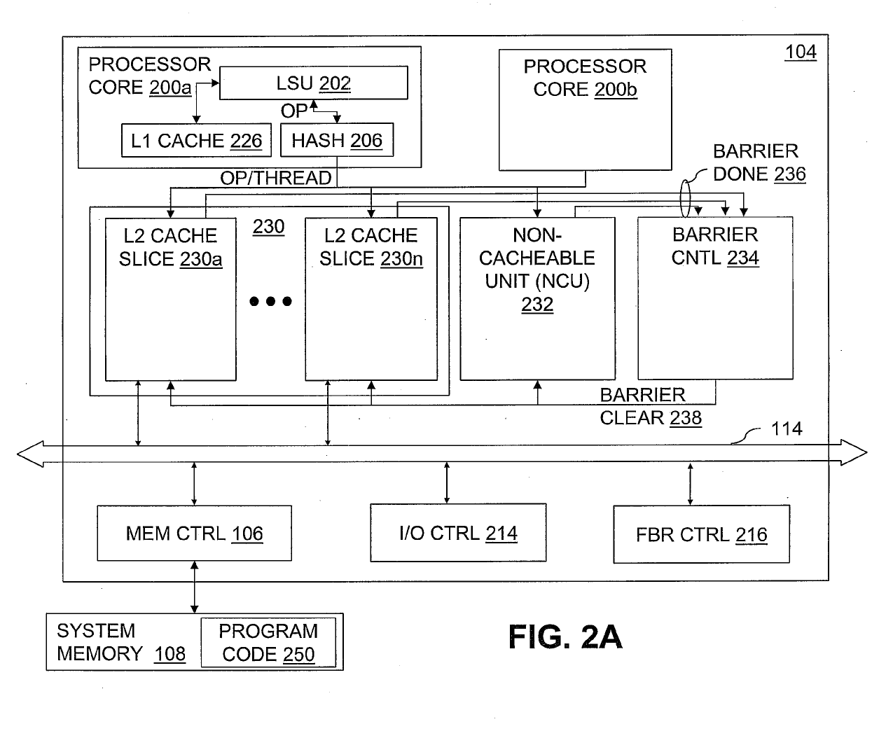

As described below in greater detail with reference to FIG. 2A, processing units 104 each include a memory controller 106 coupled to local interconnect 114 to provide an interface to a respective system memory 108. Data and instructions residing in system memories 108 can generally be accessed and modified by a processor core in any processing unit 104 of any processing node 102 within data processing system 100. In alternative embodiments of the invention, one or more memory controllers 106 (and system memories 108) can be coupled to system interconnect 110 rather than a local interconnect 114.

Those skilled in the art will appreciate that SMP data processing system 100 of FIG. 1 can include many additional non-illustrated components, such as interconnect bridges, non-volatile storage, ports for connection to networks or attached devices, etc. Because such additional components are not necessary for an understanding of the present invention, they are not illustrated in FIG. 1 or discussed further herein. It should also be understood, however, that the enhancements provided by the present invention are applicable to cache coherent data processing systems of diverse architectures and are in no way limited to the generalized data processing system architecture illustrated in FIG. 1.

Referring now to FIG. 2A, there is depicted a more detailed block diagram of an exemplary processing unit 104 in accordance with the present invention. In the depicted embodiment, each processing unit 104 includes two processor cores 200a, 200b for independently processing instructions and data. In one preferred embodiment, each processor core 202 supports multiple (e.g., two) concurrent hardware threads of execution. As depicted, each processor core 200 includes one or more execution units, such as load-store unit (LSU) 202, for executing or interpreting instructions within program code, such as program code 250. The instructions executed by LSU 202 include memory access instructions, such as load and store instructions, which request access to a memory block or cause the generation of a request for access to a memory block.

In an exemplary embodiment, store instructions may take the form depicted in FIG. 2B. As shown, exemplary store instruction 260 includes an operation code (opcode) field 262 specifying the operation (e.g., a store operation) to be performed and an operand field 268 specifying one or more operands of the specified operation, for example, identifiers of registers containing the store data and data from which the target real address of the target memory block to which the data is to be written will be computed. As further illustrated in FIG. 2B, store operation 260 further includes one or more store gathering duration fields that may optionally form a portion of opcode field 262. In this example, the store gathering duration fields include a long gathering window (LGW) field 264 and a short gathering window (SGW) field 266 whose values together indicate a desired minimum duration of a store gathering window for the store operation specified by store instruction 260.

In an exemplary embodiment, LGW field 264 is set to “1” and SGW field 266 is set to “0” to indicate that a long store gathering window should be applied to the store operation specified by store instruction 260, and LGW field 264 is set to “0” and SGW field 266 is set to “1” to indicate that a short store gathering window (which can have a duration of 0 cycles) should be applied to the store operation specified by store instruction 260. A value of “11” for LGW field 264 and SGW field 266 is illegal, and a value of “00”, which is the default value, preferably indicates an intermediate store gathering window. In this manner, a programmer or compiler can mark fields 264 and 266 of particular store instructions 260 to establish an optimal minimum store gathering window duration for those store instructions. Store instructions within program code 250 that are either purposely unmarked by the programmer and/or compiler or are unmarked because program code 250 is legacy object code are assigned the default intermediate store gathering window duration.

Returning to FIG. 2A, the operation of each processor core 200 is supported by a multi-level volatile memory subsystem having at its lowest level shared system memory 108, and at its upper levels one or more levels of cache memory, which in the illustrative embodiment include a store-through level one (L1) cache 226 within and private to each processor core 200, and a respective store-in level two (L2) cache 230 shared by processor cores 200a, 200b. In order to efficiently handle multiple concurrent memory access requests to cacheable addresses, L2 cache 230 is implemented with multiple L2 cache slices 230a-230n, each of which handles memory access requests for a respective set of real memory addresses.

Although the illustrated cache hierarchies includes only two levels of cache, those skilled in the art will appreciate that alternative embodiments may include additional levels (L3, L4, etc.) of on-chip or off-chip in-line or lookaside cache, which may be fully inclusive, partially inclusive, or non-inclusive of the contents the upper levels of cache.

Processing unit 104 further includes a non-cacheable unit (NCU) 232 that performs memory accesses to non-cacheable real memory addresses and a barrier controller 234 that enforces barrier operations that synchronize store operations across L2 cache slices 230a-230n and NCU 232. As indicated, to support such synchronization, barrier controller 234 is coupled to each of L2 cache slices 230a-230n and NCU 232 by a respective one of barrier done signals 236 and is coupled to all of L2 cache slices 230a-230n and NCU 232 by a barrier clear signal 238.

Each processing unit 104 further includes an integrated I/O (input/output) controller 214 supporting the attachment of one or more I/O devices. I/O controller 214 may issue read and write operations on its local interconnect 114 and system interconnect 110, for example, in response to requests by attached I/O device (not depicted). Communication on the communication fabric comprising local interconnect 114 and system interconnect 110 is controlled by a fabric controller 216.

In operation, when a hardware thread of execution under execution by a processor core 200 includes a memory access instruction requesting a specified memory access operation to be performed, LSU 202 executes the memory access instruction to determine the target real address of the memory access operation. LSU 202 then transmits to hash logic 206 with its processor core 200 at least the memory access operation (OP), which includes at least a transaction type (ttype) and a target real address. Hash logic 206 hashes the target real address to identify the appropriate destination (e.g., L2 cache slice 230a-230n or NCU 232) and dispatches the operation to the destination for processing.

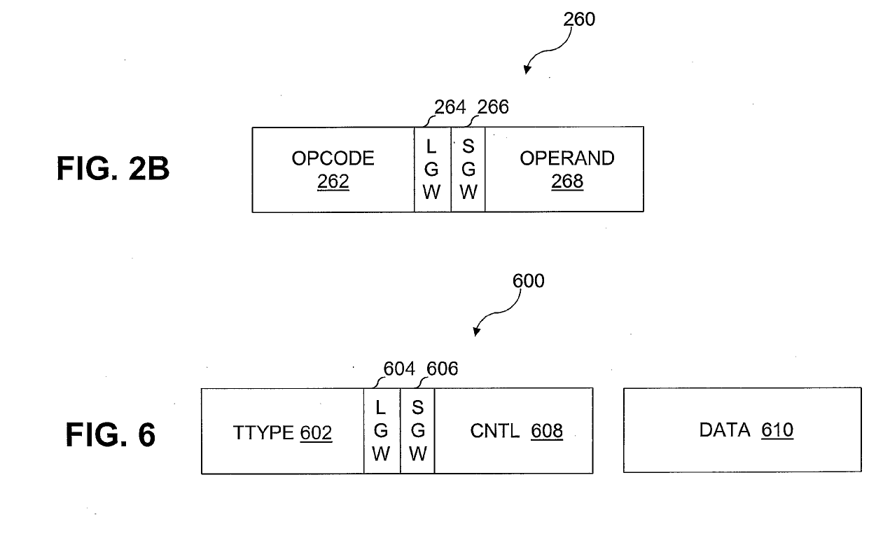

With reference now to FIG. 3, there is illustrated a more detailed block diagram of an exemplary embodiment of one of L2 cache slice 230a-230n (in this case, L2 cache slice 230a) in accordance with the present invention. As shown in FIG. 3, L2 cache slice 230a includes a cache array 302 and a directory 308 of the contents of cache array 302. Assuming cache array 302 and directory 308 are set associative as is conventional, memory locations in system memories are mapped to particular congruence classes within cache array 302 utilizing predetermined index bits within the system memory (real) addresses. The particular memory blocks stored within cache array 302 are recorded in cache directory 308, which contains one directory entry for each cache line in cache array 302. While not expressly depicted in FIG. 3, it will be understood by those skilled in the art that each directory entry in cache directory 308 includes various entry identifier and indexing fields such as tag fields for using a tag portion of the corresponding real address to specify the particular cache line stored in cache array 302, state fields that indicate the coherency state of the cache lines, and a LRU (Least Recently Used) field indicating a replacement order for the cache line with respect to other cache lines in the same congruence class.

L2 cache slice 230a includes multiple (e.g., 16) Read-Claim (RC) machines 312a-312n for independently and concurrently servicing cacheable load (LD) and store (ST) requests received from the affiliated processor core 200. In order to service remote memory access requests originating from processor cores 200 other than the affiliated processor core 200, L2 cache slice 230a also includes multiple snoop machines 311a-311m. Each snoop machine 311 can independently and concurrently handle a remote memory access request “snooped” from local interconnect 114. As will be appreciated, the servicing of memory access requests by RC machines 312 may require the replacement or invalidation of memory blocks within cache array 302. Accordingly, L2 cache slice 230a further includes CO (castout) machines 310 that manage the removal and writeback of memory blocks from cache array 302.

L2 cache slice 230a further includes an arbiter 305 that controls multiplexers M1-M2 to order the processing of local memory access requests received from affiliated processor core 200 and remote requests snooped on local interconnect 114. Memory access requests, including local load and store operations and remote read and write operations, are forwarded in accordance with the arbitration policy implemented by arbiter 305 to a dispatch pipeline 306 where each load and store request is processed with respect to directory 308 and cache array 302 over a given number of cycles.

L2 cache slice 230a also includes an RC queue 320 and a CPI (castout push intervention) queue 318 that respectively buffer data being inserted into and removed from the cache array 302. RC queue 320 includes a number of buffer entries that each individually correspond to a particular one of RC machines 312 such that each RC machine 312 that is dispatched retrieves data from only the designated buffer entry. Similarly, CPI queue 318 includes a number of buffer entries that each individually correspond to a particular one of the castout machines 310 and snoop machines 311, such that each CO machine 310 and each snooper 311 that is dispatched retrieves data from only the respective designated CPI buffer entry.

Each RC machine 312 also has assigned to it a respective one of multiple RC data (RCDAT) buffers 322 for buffering a memory block read from cache array 302 and/or received from local interconnect 114 via reload bus 323. At least some of RCDAT buffers 322 have an associated multiplexer M4 that selects data bytes from among its inputs for buffering in the RCDAT buffer 322 in response unillustrated select signals generated by arbiter 305. Among the inputs of multiplexer M4 is the output of Error Correcting Code (ECC) logic 344, which detects and corrects errors in cache lines read from cache array 302.

In operation, processor store requests comprising a transaction type (ttype), target real address and store data are received from the affiliated processor core 200 within a store queue (STQ) 304. From STQ 304, the store data are transmitted to multiplexer M4 via data path 324, and the store type and target address are passed to multiplexer M1. Multiplexer M1 also receives as inputs processor load requests from processor core 200 and directory write requests from RC machines 312. In response to unillustrated select signals generated by arbiter 305, multiplexer M1 selects one of its input requests to forward to multiplexer M2, which additionally receives as an input a remote request received from local interconnect 114 via remote request path 326. Arbiter 305 schedules local and remote memory access requests for processing and, based upon the scheduling, generates a sequence of select signals 328. In response to select signals 328 generated by arbiter 305, multiplexer M2 selects either the local request received from multiplexer M1 or the remote request snooped from local interconnect 114 as the next memory access request to be processed. The processing of local requests can include, inter alia, returning read data to processor core 200 via multiplexer M3 or placing store data within cache array 302 via multiplexer M4, an RCDAT buffer 322, and signal lines 350.

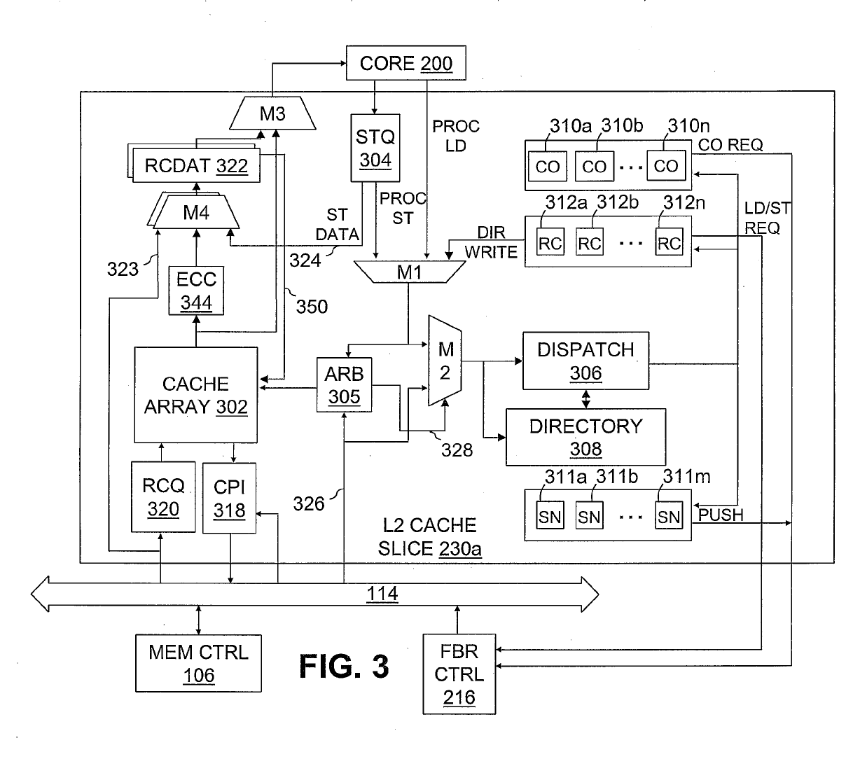

Referring now to FIG. 4, there is illustrated a more detailed block diagram of an L2 store queue 304 within an L2 cache slice 230a-230n in accordance with the present invention. As shown, L2 store queue (STQ) 304 includes L2 STQ controller 430 and buffer storage for each hardware thread supported by the associated processor cores 200. The buffer storage for each hardware thread includes multiple entries 400 each having a number of fields for holding information for a particular store operation.

In the depicted embodiment, the fields of each entry 400 include a valid (V) field 402 indicating the validity of the contents of the entry 400, a transaction type (ttype) field 404 for holding a transaction type of an operation, an address (ADDR) field 406 for holding the target real address of an operation, a data field 408 for holding store data of the operation, control latches 410, a counter field 412 that, for gatherable store operations, maintains a count value indicative of a remaining duration of a store gathering window for the operation, a gatherable flag 414 indicating whether or not the operation is gatherable, a dispatchable flag 416 indicating whether or not the operation is ready for dispatch to dispatch pipeline 306, and a window size field 418 indicating whether the minimum duration of the store gathering window for the operation is long, intermediate (which is the default) or short.

As further shown in FIG. 4, L2 STQ controller 430 further includes a long gather window count register 432, intermediate gather window count register 434, and a short gather window count register 436. These three registers hold three initial count values for counter fields 412 respectively representing the durations of a long store gathering window, an intermediate store gathering window and a short store gathering window. The initial count values are preferably established in registers 432-436 at system startup by initialization firmware or software, as is known to those skilled in the art.

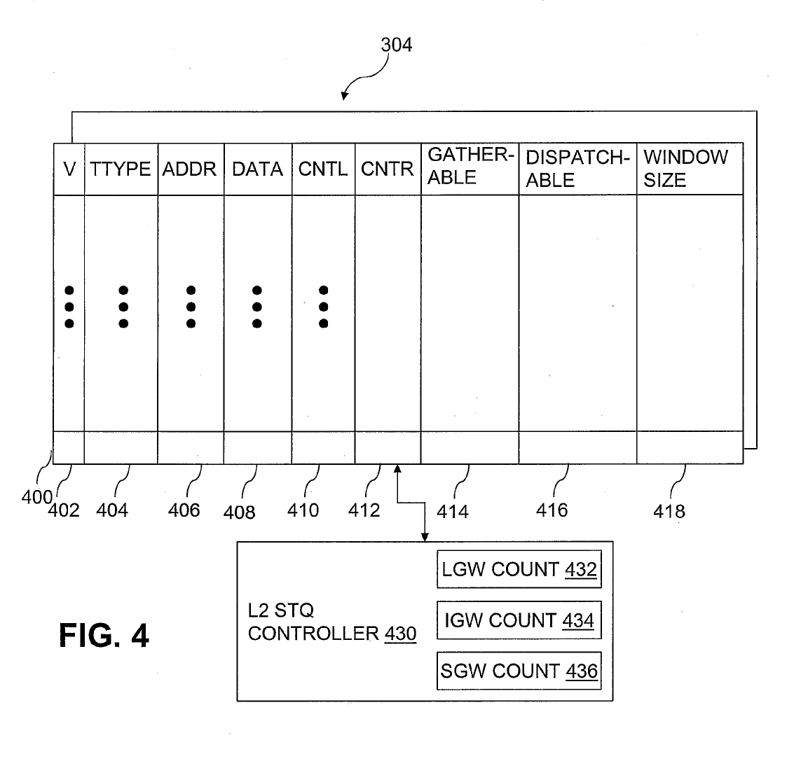

With reference now to FIG. 5, there is illustrated a high level logical flowchart of an exemplary per-thread process by which a store queue controller, such as L2 STQ controller 430, places store operations into buffer storage of a store queue of a cache memory in accordance with the present invention. As shown, the process begins at block 500 and thereafter proceeds to block 502, which depicts L2 STQ controller 430 iterating until a request is received from the associated processor core 200. In response to receipt of a request from the associated processor core 200, L2 STQ controller 430 determines by reference to the ttype of the request whether or not the received request is a barrier operation, such as a SYNC operation (block 504). If not, the process proceeds from block 504 to block 510, which is described below. If, however, L2 STQ controller 430 determines that the received request is a barrier operation, L2 STQ controller 430 resets the gatherable flag 414 of all valid entries 400 for the relevant thread to close gathering for all such entries 400 and sets the dispatchable flag(s) 416 of all such entries 400 to indicate that the store operations buffered in the entry or entries 400 are ready to be dispatched to dispatch pipeline 306 for processing. In order to observe the synchronization mandated by the barrier operation, each L2 slice 230 and NCU 232 processes all memory access operations preceding the barrier operation and signals completion of such processing by asserting its barrier done signal 236 to barrier controller 234 (see, e.g., FIG. 2A) When all the barrier done signals 236 of L2 cache slices 230 and NCU 232 have been asserted, barrier controller 234 asserts barrier clear signal 238 to indicate that memory access operations following the barrier operation can be performed. Following block 506 of FIG. 5, the process returns to block 502, which has been described.

Referring now to block 510, L2 STQ controller 430 also determines by reference to the ttype and target address of the received request if the received request is a load request that hits the target real address specified in the address field 406 of a queued store operation, that is, whether the target real address of the load request falls within the same cache line as a previous store operation whose entry 400 is yet to be dispatched. If not, the process passes to block 514, which is described below. If so, the process proceeds from block 510 to block 512, which depicts L2 STQ controller 430 resetting the gatherable flag 414 and setting the dispatchable flag 416 of the matching entry 400 to close store gathering for the entry 400 and to indicate that the store operation contained therein is dispatchable to dispatch pipeline 306 for processing. In this manner, the store operation is performed in advance of the conflicting load request (which is held up), ensuring that the load request does not return stale data to the requesting processor core 200. Following block 512, the process returns to block 502.

With reference now to block 514, L2 STQ controller 430 determines by reference to the ttype if the request received from the associated processor core 200 is a store operation. If not, for example, if the request is a load request that fails to hit in L2 STQ 304, the request is discarded, and the process returns to block 502 to await the next request. If, however, L2 STQ controller 430 determines at block 514 that the request received from processor core 200 is a store operation, the process passes to block 520.

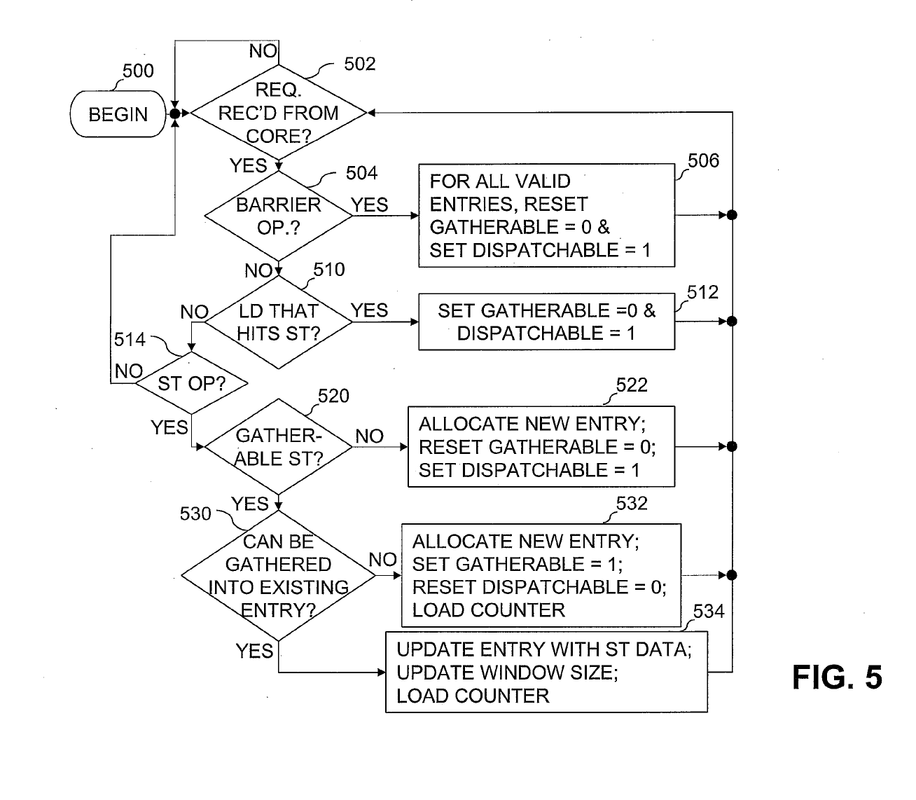

As shown in FIG. 6, an exemplary store operation 600 received by L2 STQ controller 430 includes a ttype field 602 indicating the type of operation (e.g., a store operation) and a control field 608 specifying the target real address and, optionally, addition control information for the store operation. Accompanying or included within store operation 600 is one or more bytes of data 610 to be stored in the target memory block. As further illustrated in FIG. 6, store operation 600 further includes one or more store gathering window duration fields, which in this embodiment include a long gathering window (LGW) field 604 and a short gathering window (SGW) field 606 corresponding to fields 264 and 266, respectively, of the corresponding store instruction 260.

Returning to FIG. 5, L2 STQ controller 430 determines at block 520 (e.g., by examining ttype field 602 and/or control field 608) if the request is a gatherable store operation or a non-gatherable store operation. If L2 STQ controller 430 determines at block 520 that the received request is a gatherable store operation, the process proceeds to block 530, which is described below. If, on the other hand, L2 STQ controller 430 determines at block 520 that the received request is a non-gatherable store operation, L2 STQ controller 430 allocates a new entry 400 to the store operation, filling in ttype field 404, address field 406 and data field 408 with information contained in the request (block 522). In addition, L2 STQ controller 430 resets gatherable flag 414 to indicate that the store operation is not gatherable and sets dispatchable flag 416 to indicate that the store operation is ready for dispatch to dispatch pipeline 306. Finally, L2 STQ controller 430 sets valid field 402 to validate the entry 400. Because the entry 400 is not gatherable, counter field 412 and window size field 418 are unused. Following block 522, the process returns to block 502.

With reference now to block 530, L2 STQ controller 430 determines whether a gatherable store operation received from the processor core 200 can be gathered into any existing valid entry 400 within the buffer storage for the relevant hardware thread. As noted above, a gatherable store operation may be gathered into the entry 400 of any previous store operation for which the target real address of the new store operation falls within the same cache line as the previous store operation and the gatherable flag 414 and valid flag 402 of the entry 400 are set. If L2 STQ controller 430 determines that the gatherable store operation cannot be gathered into any existing entry 400, the process passes to block 532.

Block 532 illustrates L2 STQ controller 430 allocating a new entry 400 to the gatherable store operation and filling in ttype field 404, address field 406 and data field 408 with information contained in the request. In addition, L2 STQ controller 430 sets gatherable flag 414 to indicate that the store operation is gatherable, resets dispatchable flag 416 to indicate that the store operation is not ready for dispatch to dispatch pipeline 306 but should be held for gathering, buffers the value of LGW field 604 and SGW field 606 in window size field 418, and initializes counter field 412 with the value of the appropriate one of registers 432-436 indicated by LGW field 604 and SGW field 606. That is, L2 STQ controller 430 initializes counter field 412 with the contents of LGW count register 432 if fields 604 and 606 have the value “10”, with the contents of IGW count register 434 if fields 604 and 606 have the value “00”, and with the contents of SGW count register 432 if fields 604 and 606 have the value “01”. Finally, L2 STQ controller 430 sets valid field 402 to validate the entry 400. The process then returns to block 502.

Returning to block 530, if L2 STQ controller 430 determines that the gatherable store operation can be gathered into a valid entry 400 of STQ 304, the process passes to block 534. Block 534 depicts L2 STQ controller 430 updating data field 408 of the previously allocated entry 400 with the one or more data bytes contained in the request. In addition, L2 STQ controller 430 updates, if necessary, window size field 418 with the value of LGW field 604 and SGW field 606 from the new store operation and reloads counter field 412 to the count value contained in the appropriate one of registers 432-436 indicated by the LGW field 604 and SGW field 606 of the new store operation. Thus, the duration of a store gathering window of an entry 400 is preferably updated each time a new store operation is gathered into that entry 400. Finally, L2 STQ controller 430 sets valid field 402 to validate the entry 400. The process then returns to block 502, which has been described.

It should be noted that the process of FIG. 5 assumes that a processor core 200 cannot overrun an L2 STQ 304 by sending store operations at a rate greater than the store operations can be serviced by an L2 cache slice 230. Those skilled in the art will appreciate that such queue management can be handled utilizing any one of a number of conventional queue management techniques, such as tokens or request-acknowledgment communication.

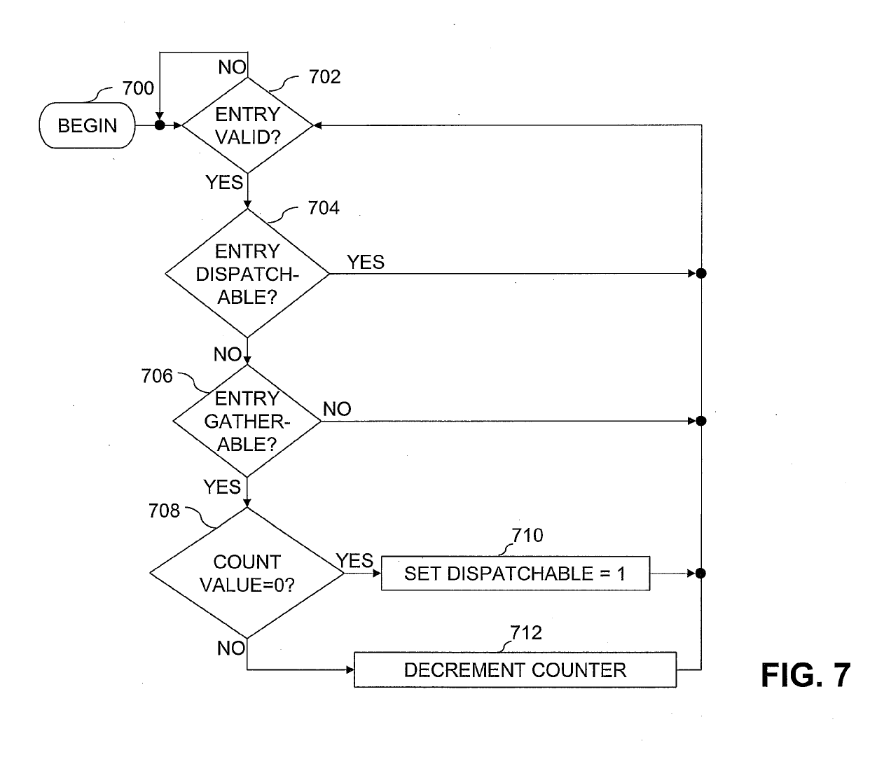

Referring now to FIG. 7, there is depicted a high level logical flowchart of an exemplary process by which a store queue controller, such as L2 STQ controller 430, manages the dispatchable status of entries within a store queue of a cache memory accordance with the present invention. The depicted process is preferably independently performed by L2 STQ controller 430 for each of entries 400 concurrently with the process illustrated in FIG. 5.

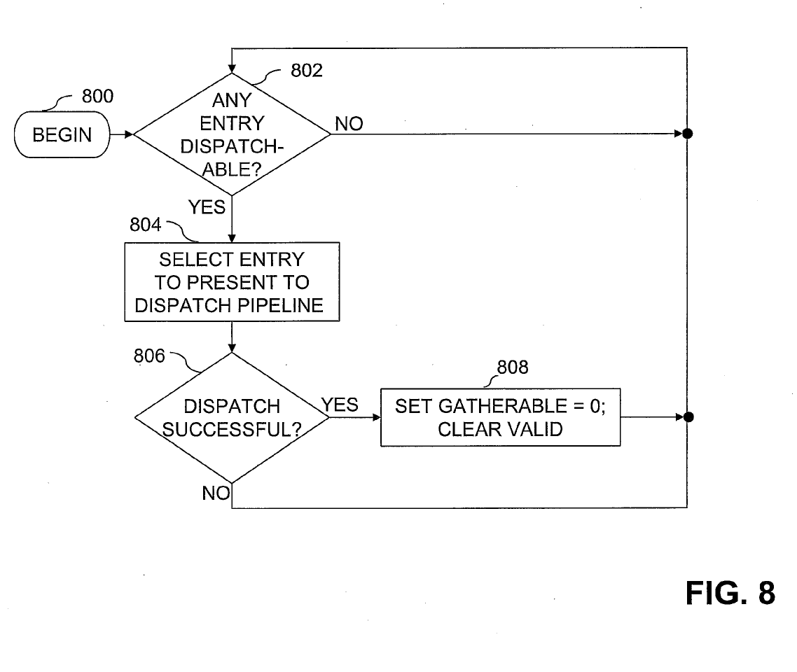

The process depicted in FIG. 7 begins at block 700 and thereafter proceeds to block 702, which depicts L2 STQ controller 430 iterating until the valid field 402 of an entry 400 is set, for example, at block 522 or block 532 of FIG. 5. In response to the valid field 402 being set, L2 STQ controller 430 determines at block 704 if the dispatchable flag 416 of the entry 400 is already set. If so, the process returns to block 702. If, however, dispatchable flag 416 is not set, L2 STQ controller 430 determines at block 706 if the gatherable flag 414 of the entry 400 is set. If not, the process returns to block 702. If, on the other hand, gatherable flag 414 is set, L2 STQ controller 430 determines at block 708 whether or not the count value in counter field 412 has reached a threshold of zero (b‘0000’). If not, L2 STQ controller 430 decrements the count value maintained in counter field 412 at block 712 to reflect the elapsing of a portion of the store gathering window for the gatherable store operation buffered in the entry 400. If, however, L2 STQ controller 430 determines at block 708 that the threshold count value has been reached, L2 STQ controller 430 sets the dispatchable flag 416 of the entry 400 at block 710 to mark the gatherable store operation contained in the entry 400 as ready to be dispatched to dispatch pipeline 306. Thus, the use of counter field 412 to track the elapsing of the store gathering window ensures that the store gathering window extends at least the desired minimum duration indicated by window size field 418 and may optionally continue further if the entry 400 is not immediately dispatched according to the process depicted in FIG. 8. Following either block 710 or block 712, the process returns to block 702 and proceeds iteratively.

The ability to control the duration of a store gathering window as described above can be advantageously exploited in a number of operating scenarios. For example, in one common operating scenario, a processor core 200 issues a sequence of one or more store operations that fall within a single memory block followed by one or more store operations targeting other memory blocks. In such scenarios, the compiler or programmer can mark all but the last of the underlying store instructions that fall within the same memory block with long store gathering window durations and mark the last of such store instructions with a store gathering window of short (e.g., zero) duration. As a result, all the store operations targeting the same memory block will be gathered into the same L2 STQ entry 400 as described above with respect to blocks 530 and 534 of FIG. 5. Because the last gathered store operation will have its LGW field 604 reset to 0 and its SGW field 606 set to 1 to indicate a short (e.g., zero) duration store gathering window, the entry 400 into which all the store operations targeting the same memory block are gathered will be rapidly (e.g., immediately) marked as dispatchable in accordance with blocks 708 and 710 of FIG. 7. In this manner, the store gathering window is held open as long as is desirable to achieve maximum gathering and then rapidly closed to permit the gathered store operation to proceed.

With reference now to FIG. 8, there is depicted a high level logical flowchart of an exemplary process by which a store queue controller, such as L2 STQ controller 430, dispatches store operations from a store queue in accordance with the present invention. The depicted process is preferably performed concurrently with the processes illustrated in FIGS. 5 and 7.

As shown, the process of FIG. 8 begins at block 800 and proceeds to block 802, which illustrates L2 STQ controller 430 determining whether any entry 400 of L2 STQ 304 has its dispatchable flag 416 set. If not, the process iterates at block 802 until at least one entry 400 is marked as dispatchable. If, however, L2 STQ controller 430 determines at block 802 that at least one entry 400 is marked by its dispatchable flag 416 as ready for dispatch, L2 STQ controller 430 selects an entry 400 so marked according to a predetermined priority scheme that respects any ordering dependencies among non-gathered entries 400 and presents the store operation buffered therein to multiplexers M1 and M2 for selection as a next memory access operation to be placed within dispatch pipeline 306. As noted above, selection of the memory access operation placed within dispatch pipeline 306 is made by arbiter 305.

If the store operation presented by L2 STQ controller 430 is not selected by arbiter 305 for dispatch to dispatch pipeline 306, dispatch fails (block 806), and the process returns to block 802. If, however, arbiter 305 selects for dispatch the store operation presented by L2 STQ controller 430, dispatch is successful (block 806). Consequently, L2 STQ controller 430 resets the gatherable flag 414 of the selected entry 400 to close the associated store gathering window and clears valid field 402 to mark the entry 400 as invalid and thus ready for allocation to a new store operation. Thereafter, the process returns to block 802.

As has been described, the present invention provides an improved data processing system, processing unit, memory subsystem and method of data processing in which store gathering windows of different durations are applied to store operations. In a preferred embodiment, the store gathering window duration is indicated to the memory subsystem by one or more store gathering window duration fields in a store operation communicated from a processor core to the memory subsystem. The values of store gathering window duration fields are preferably determined by the processor core based upon one or more store gathering window duration hints encoded within a corresponding store instruction executed by the processor core.

While the invention has been particularly shown as described with reference to a preferred embodiment, it will be understood by those skilled in the art that various changes in form and detail may be made therein without departing from the spirit and scope of the invention. For example, although aspects of the present invention have been described with respect to a data processing system executing program code that directs the functions of the present invention, it should be understood that present invention may alternatively be implemented as a program product for use with a data processing system. Program code defining the functions of the present invention can be delivered to a data processing system via a variety of signal-bearing media, which include, without limitation, non-rewritable storage media (e.g., CD-ROM), rewritable storage media (e.g., a floppy diskette or hard disk drive), and communication media, such as digital and analog networks. It should be understood, therefore, that such signal-bearing media, when carrying or encoding computer readable instructions that direct the functions of the present invention, represent alternative embodiments of the present invention.

What is claimed is:

1. A data processing system, comprising:
a processor core; and
a memory subsystem coupled to the processor core, said memory subsystem including:
data storage;
a store queue including a plurality of entries for buffering store operations to be performed with reference to said data storage; and
a store queue controller that gathers multiple store requests received from the processor core into a single store operation buffered within an entry of the store queue, wherein said store queue controller applies store gathering windows of differing durations to differing ones of said plurality of entries in response to control information received from the processor core.

2. The data processing system of claim 1, wherein:
each entry among said plurality of entries of said store queue has an associated counter that, when active, has a count value indicative of elapsed time in a store gathering window for that entry; and
said store queue controller updates a status of a particular entry to a dispatchable state in response to the count value of a counter for that entry reaching a count value corresponding to duration of the store gathering window of that particular entry.

3. The data processing system of claim 1, wherein:
each of said plurality of entries has an associated duration field having a plurality of possible settings capable of indicating at least a short store gathering window duration, an intermediate store gathering window duration, and a long store gathering window duration.

4. The data processing system of claim 3, wherein said short store gathering window duration is zero cycles.

5. The data processing system of claim 3, wherein:
said store queue controller receives gathering receives a gathering window duration hint from processor core with a store request; and
said store queue controller establishes a setting of the duration field of an entry utilized to buffer the store request by reference to the gathering window duration hint.

6. The data processing system of claim 5, wherein:
said store request is a first store request;
said store queue controller, responsive to receipt of a second store request that may be gathered into the entry in said store queue allocated to said first store request, said second store request having an associated gathering window duration hint, gathers data of said second store request into said entry and updates said setting of said duration field in accordance with said gathering window duration hint of said second store request.

7. The data processing system of claim 6, wherein:
said entry of said store queue has an associated counter that has a count value indicative of elapsed time in a store gathering window for that entry; and
said store queue controller resets said count value to an initial value in response to said second store request.

8. The data processing system of claim 5, wherein:
said processor core, responsive to receiving a store instruction containing said gathering window duration hint, executes said store instruction to generate a target address of a store request corresponding to the store instruction and transmits said store request and said gathering window duration hint to said memory subsystem.

9. A method of data processing, comprising:
receiving multiple store operations from a processor core at a memory subsystem of a data processing system;
in response to receipt of the store operations, buffering, in each of a plurality of entries in a store queue of the memory subsystem, a respective store operation to be performed with reference to data storage;
gathering multiple store operations received from the processor core into particular ones of the entries of the store queue; and
applying store gathering windows of differing minimum durations to differing ones of said plurality of entries in response to control information received from the processor core.

10. The method of claim 9, wherein:
maintaining, for each entry among said plurality of entries of said store queue, an associated counter that, when active, has a count value indicative of elapsed time in a store gathering window for that entry; and
updating a status of a particular entry to a dispatchable state in response to the count value of a counter for that entry reaching a count value corresponding to duration of the store gathering window of that particular entry.

11. The method of claim 9, wherein:
said applying step includes setting a duration field for one of said plurality of entries to one of a plurality of possible settings, wherein said plurality of possible settings are capable of indicating at least a short store gathering window duration, an intermediate store gathering window duration, and a long store gathering window duration.

12. The method of claim 11, wherein said short store gathering window duration is zero cycles.

13. The method of claim 11, and further comprising receiving a gathering window duration hint from the processor core with a store operation, wherein said applying includes establishing a setting of the duration field of the entry utilized to buffer the store operation by reference to the gathering window duration hint.

14. The method of claim 13, wherein:
said store operation is a first store operation; and
said applying includes:
in response to receipt of a second store operation that may be gathered into the entry in said store queue allocated to said first store operation, said second store request having an associated gathering window duration hint, updating said setting of said duration field in accordance with said gathering window duration hint of said second store operation.

15. The method of claim 14, wherein:
said entry of said store queue has an associated counter that has a count value indicative of elapsed time in a store gathering window for that entry; and
said updating comprising resetting said count value to an initial value in response to said second store operation.

16. The method of claim 11, and further comprising:
in response to receiving a store instruction containing said gathering window duration hint, said processor core executing said store instruction to generate a target address of a store operation corresponding to the store instruction and transmitting said store operation and said gathering window duration hint to said memory subsystem.

17. A program product, comprising:
a computer-readable medium readable by a computer; and
program code encoded within said computer-readable medium, said program code including a plurality of instructions including a store instruction and a gathering window size hint associated with the store instruction, wherein said gathering window size hint indicates a duration of store gathering window to be applied by the computer to a store operation indicated by the store instruction.

18. The program product of claim 17, wherein:
said gathering window size hint has a plurality of possible settings capable of indicating at least a short store gathering window duration, an intermediate store gathering window duration, and a long store gathering window duration.

19. The program product of claim 17, wherein:
said store instruction comprises a first store instruction;
said gathering window size hint is a first gathering window size hint;
said program code includes a second store instruction following said first store instruction in program order and an associated second gathering window size hint; and
said second gathering window size hint indicates a different store gathering window size than said first gathering window size hint.

20. The program product of claim 19, wherein said second gathering window size hint indicates a shorter store gathering window size than said first gathering window size hint.
